(19) United States
(12) Patent Application Publication
(10) Pub. No.: US 2026/0332335 A1
(43) Pub. Date: Oct. 22, 2026

(54) COMMUNICATION METHOD AND APPARATUS, AND COMMUNICATION DEVICE

(71) Applicant: BEIJING XIAOMI MOBILE SOFTWARE CO., LTD., Beijing (CN)

(72) Inventors: Liangang CHI, Beijing (CN); Gaoming DUAN, Beijing (CN)

(73) Assignee: BEIJING XIAOMI MOBILE SOFTWARE CO., LTD., Beijing (CN)

(21) Appl. No.: 19/491,048

(22) PCT Filed: Jun. 13, 2023
(86) PCT No.: PCT/CN2023/100035

§ 371 Date: Dec. 8, 2025

(51) Int. Cl. H04L 5/00; H04B 7/0413

(52) U.S. Cl. CPC H04L 5/0048; H04L 5/001; H04B 7/0413

(57) ABSTRACT

A communication method performed by a transmitter, includes: sending, at a reference signal sending position in a reference signal pattern, one or more reference signals corresponding to one or more antenna ports, wherein the reference signal pattern is used for an orthogonal time frequency and space (OTFS) modulation system.

### CROSS-REFERENCE TO RELATED APPLICATIONS

This application is a U.S. National Phase of International Application No. PCT/CN2023/100035, filed with the State Intellectual Property Office of P. R. China on Jun. 13, 2023, the entire contents of which are incorporated herein by reference.

### TECHNICAL FIELD

The disclosure relates to the field of mobile communication technologies, in particular to a communication method, an apparatus and a communication device.

### BACKGROUND

The most current wireless communication systems can only guarantee higher data transmission rates and provide high-quality services in low/medium-mobility scenarios. In high-mobility scenarios, however, their coverage range and transmission efficiency are severely constrained. Orthogonal time frequency and space (OTFS) modulation offers more significant performance gains than existing modulation schemes such as orthogonal frequency division multiplexing (OFDM). Multiple-input multiple-output (MIMO) multi-antenna technologies fully utilizes spatial resources and significantly enhancing the spectral efficiency of wireless communication systems. The MIMO-OTFS system combines the advantages of multi-antenna technologies and OTFS waveforms, balancing the demands of high-speed mobility and high spectral efficiency. However, no solution has yet been found for the transmission of the reference signal (RS) in MIMO-OTFS systems.

### SUMMARY

According to a first aspect, the embodiments of the disclosure provide a communication method. The method is performed by a transmitter, and includes: sending one or more RSs corresponding to one or more antenna ports at an RS sending position in an RS pattern, in which the RS pattern is used for an OTFS modulation system.

According to a second aspect, the embodiments of the disclosure provide a communication method. The method is performed by a receiver, and includes: receiving one or more RSs corresponding to one or more antenna ports at an RS sending position in an RS pattern, in which the RS pattern is used for an OTFS modulation system.

According to a third aspect, the embodiments of the disclosure provide a communication device. The communication device includes: a transceiver, a memory, and a processor connected to the transceiver and the memory, respectively. The processor is configured to control wireless signal transmission and reception of the transceiver and to implement the method in the embodiments of the first aspect or the second aspect of the disclosure by executing computer-executable instructions on the memory.

### BRIEF DESCRIPTION OF THE DRAWINGS

The above and/or additional features and advantages of the disclosure will become apparent and easily understood from the following descriptions of the embodiments in combination with the accompanying drawings, in which:

FIG. 1 is a flowchart of a communication method according to an embodiment of the disclosure.

FIG. 2 is a flowchart of a communication method according to an embodiment of the disclosure.

FIG. 3 is a schematic diagram of an RS pattern according to an embodiment of the disclosure.

FIG. 4 is a flowchart of a communication method according to an embodiment of the disclosure.

FIG. 5 is a flowchart of a communication method according to an embodiment of the disclosure.

FIG. 6 is a flowchart of a communication method according to an embodiment of the disclosure.

FIG. 7 is a flowchart of a communication method according to an embodiment of the disclosure.

FIG. 8 is an interactive schematic diagram of a communication method according to an embodiment of the disclosure.

FIG. 9 is a schematic block diagram of a communication apparatus according to an embodiment of the disclosure.

FIG. 10 is a schematic block diagram of a communication apparatus according to an embodiment of the disclosure.

FIG. 11 is a schematic block diagram of a communication apparatus according to an embodiment of the disclosure.

FIG. 12 is a schematic block diagram of a communication apparatus according to an embodiment of the disclosure.

FIG. 13 is a schematic structural diagram of a communication device according to an embodiment of the disclosure.

FIG. 14 is a schematic structural diagram of a chip according to an embodiment of the disclosure.

### DETAILED DESCRIPTION

The embodiments of the disclosure will be described in detail, examples of which are illustrated in the accompanying drawings, in which the same or similar reference numerals indicate the same or similar elements or elements having the same or similar functions throughout. The embodiments described below with reference to the accompanying drawings are exemplary and are intended to explain the disclosure, and should not be construed as limiting the disclosure.

To facilitate understanding of the embodiments of the disclosure, related arts involved in the disclosure are introduced below.

In recent years, the large-scale development of high speed railway (HSR) and the increasing popularity of vehicle communication systems on motorways have drawn widespread attention to wireless communication systems operating in high-mobility scenarios. The 5th generation (5G) system is dedicated to providing users aboard trains traveling at speeds up to 500 km/h or other highly mobile vehicles with burst-capable broadband services, guaranteeing data transmission rates of 150 Mbps. However, most current wireless communication systems can only ensure high data transmission rates and provide high-quality services in low/medium-mobility scenarios. In high-mobility scenarios, their coverage range and transmission efficiency are severely constrained.

The communication system operating in high-mobility scenarios primarily encounter the following challenges. (1) Rapid time-varying fading. Increased mobility induces significant Doppler frequency shifts and spreading within the communication system, causing severe degradation in communication performance. Concurrently, variations in terminal velocity lead to alterations in attenuation coefficients and time-varying Doppler spreading. The rapid evolution of the wireless transmission environment further complicates channel analysis and modeling. (2) Frequency offset issues arise. At the receiver of the system, Doppler frequency shift in the received signals cause frequency mismatch between transmitter and receiver. In multi-carrier systems, carrier frequency offset (CFO) compromises inter-carrier orthogonality and introduces inter-carrier interference (ICI). In high-mobility scenarios, the time-varying nature of Doppler shifts poses new challenges to the accuracy of Doppler estimation and tracking. In high-mobility scenarios, designing novel network architectures to accommodate these characteristics and ensure communication performance requirements alongside guaranteeing the reliability and accuracy of rapid and frequent handover operations, and addressing the high signal penetration loss introduced by HSR systems, have become pressing issues requiring resolution in this scenario.

OTFS modulation is a two-dimensional modulation scheme designed in a delay-Doppler (DD) domain, which is different from previous modulation schemes based on a time-frequency (TF) domain. Through a series of two-dimensional conversions, it converts a double-dispersion channel into an approximately flat fading channel in the DD domain. In this domain, every symbol in a data frame will experience the same almost constant fading, which has more significant performance gain over existing modulation schemes such as OFDM. MIMO multi-antenna technologies fully utilizes spatial resources, significantly enhancing the spectral efficiency of wireless communication systems. It has become a key technology in current wireless communications.

In summary, the MIMO-OTFS system integrates the advantages of multi-antenna technologies and OTFS waveforms, balancing the demands of high-speed mobility and high spectral efficiency. It addresses challenges faced by existing communication systems in high-mobility scenarios. However, within researches and applications of MIMO-OTFS systems, no solution has yet been found for the transmission of RSs in MIMO-OTFS systems.

Therefore, the disclosure provides a communication method, an apparatus and a communication device, establishing an RS sending position pattern and an RS sending solution. The transmitter sends the one or more RSs corresponding to the one or more antenna ports to the receiver at the RS sending location in the RS pattern. The RS pattern is used for an OTFS modulation system. The sending solution can by applicable to MIMO-OTFS systems, enabling the transmission of RS within such systems and resolving the issue of RS transmission being unavailable in MIMO-OTFS systems.

The communication method provided by the disclosure will be described in detail in combination with the accompanying drawings.

Firstly, the embodiment of the disclosure provides a communication system, including a transmitter and a receiver. The communication system includes, but is not limited to, one transmitter and one receiver. In practical applications, for example, it may include one or more transmitters and one or more receivers.

It is noteworthy that the technical solution of the embodiments of the disclosure can be applicable to various communication systems, such as, a long term evolution (LTE) system, a 5G mobile communication system, a 5G new radio (NR) system, or other future new mobile communication systems.

In the embodiment of the disclosure, the transmitter may be a terminal or a network device. Correspondingly, the receiver may be a network device or a terminal, which is not limited in the disclosure.

The network device in the embodiment of the disclosure is an entity on a network side for transmitting or receiving signals. For example, the network device may be an evolved NodeB (eNB), a transmission reception point (TRP), a next generation NodeB (gNB) in a NR system, a base station in other future mobile communication systems or an access node in a wireless fidelity (Wi-Fi) system. The specific technology and device form adopted by the network device are not limited in the embodiment of the disclosure.

The network device in the embodiment of the disclosure is composed of a central unit (CU) and a distributed unit (DU). The CU may also be referred to as control unit. The use of CU-DU structure allows to divide a protocol layer of the network device, such as a base station, such that some protocol layer functions are placed in the CU for centralized control, and part or all of the remaining protocol layer functions are distributed in the DU, which is centrally controlled by the CU.

The terminal in the embodiment of the disclosure is an entity on a user side for receiving or transmitting signals, such as a cellular phone. The terminal may also be referred to as terminal, user equipment (UE), mobile station (MS), mobile terminal (MT), and the like. The terminal may be a car with a communicating function, a smart car, a mobile phone, a wearable devices, a Pad, a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and device form adopted by the terminal are not limited in the embodiment of the disclosure.

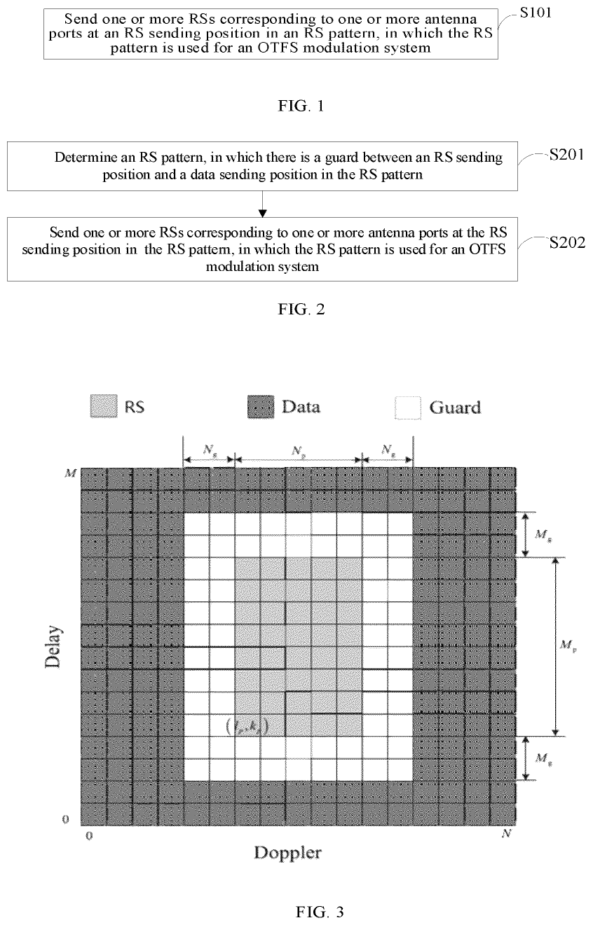

FIG. 1 is a flowchart of a communication method according to an embodiment of the disclosure. As illustrated in FIG. 1, the method is performed by a transmitter.

As illustrated in FIG. 1, the method includes the following steps.

At step S101, one or more RSs corresponding to one or more antenna ports are sent at an RS sending position in an RS pattern.

The RS pattern is used for an OTFS modulation system.

In the embodiments of the disclosure, the RS may also be referred to as a “pilot” signal, which is a known signal sent by the transmitter to a receiver for channel estimation or channel detection. The RS includes, but is not limited to, a demodulation RS (DMRS), a phase tracking RS (PTRS), a sounding RS (SRS) and a channel state information RS (CSI-RS).

In the embodiments of the disclosure, the transmitter may be a terminal or a network device. For example, when the transmitter is a network device, the RS may be a DMRS. Or, when the transmitter is a terminal, the RS may be a SRS.

In the embodiments of the disclosure, the RS pattern is used for the OTFS modulation system to transmit information in the DD domain. The position coordinates in the RS pattern include a coordinate in the delay domain and a coordinate in the Doppler domain. The disclosure specifies the RS sending position through the RS pattern, e.g., by defining a coordinate in the Doppler domain and a coordinate in the delay domain of the RS sending position in the RS pattern.

In some embodiments of the disclosure, each antenna port has the same RS pattern, meaning that each antenna port sends an RS at the same position in the DD domain.

In some embodiments of the disclosure, different antenna ports has different RS sequences. The transmitter may map RS sequences of one or more antenna ports onto the same RS sending position in the DD domain. That is, one or more RSs are sent at the RS sending position.

In some embodiments of the disclosure, since the RS sequences used by different antenna ports exhibit orthogonality, when the transmitter sends one or more RSs corresponding to several antenna ports, different antenna ports are distinguished through the orthogonality of RS sequences of different antenna ports, which ensures that signal transmission does not interfere with one another, thereby making it suitable for application in MIMO multi-antenna systems.

It should be noted that the solution disclosed in the disclosure is applicable to an OTFS modulation system or a MIMO multi-antenna system, to solve the issue of RS transmission in the MIMO-OTFS system or to promote the construction of the MIMO-OTFS system, so as to promote the construction of communication systems that meet their communication performance requirements in high-mobility scenarios.

According to the communication method disclosed in the disclosure, the transmitter sends the one or more RSs corresponding to the one or more antenna ports at the RS sending position in the RS pattern, in which the RS pattern is used for the OTFS modulation system. The communication method is applied to the MIMO-OTFS system, to realize the function of sending the RS in the MIMO-OTFS system.

On the basis of the embodiment of FIG. 1, FIG. 2 is a flowchart of a communication method according to an embodiment of the disclosure. The method is performed by a transmitter. For convenience of understanding, FIG. 3 is a schematic diagram of an RS pattern provided by the disclosure.

As illustrated in FIG. 2, the method includes the following steps.

At step S201, an RS pattern is determined.

There is a guard between an RS sending position and a data sending position in the RS pattern. The guard can block the negative effects of time-delay frequency shift and Doppler frequency shift.

In some embodiments, FIG. 3 illustrates a schematic diagram of an RS pattern provided by the disclosure. As illustrated in FIG. 3, the RS pattern includes an RS sending position, a data sending position and a guard, and the guard is located between the RS sending position and the data sending position.

It should be noted that in a DD domain, due to delay/Doppler frequency shift, a signal placed at zero at the transmitter may be received as non-zero at the receiver (subject to channel's impulse response). As the DD channel exhibits multipath propagation, where delay and Doppler are non-unique, setting guard intervals facilitates channel estimation. The resulting estimates may be utilized for channel demodulation and or for feeding back CSI.

In some embodiments, the guard should be greater than or equal to the maximum delay spread of the channel in the delay domain and greater than or equal to the maximum Doppler frequency shift in the Doppler domain.

In some embodiments of the disclosure, determining the RS pattern, includes: determining the number of antenna ports; determining a configuration parameter of the RS pattern; and determining the RS pattern according to a protocol based on the number of antenna ports and the configuration parameter.

For example, when applied to a 5G NR system, the NR system supports 1, 2, 4, 8, 12, 16, 24, or 32 antenna ports. The number of antenna ports may also be other values, which is not limited in the disclosure.

In the embodiments of the disclosure, the magnitude of the configuration parameter is determined based on the number of antenna ports. For example, where the number of antenna ports comprises 4, 8, 12 and 16, four sets of configuration parameters standards are generated respectively for 4, 8, 12 and 16 antenna ports. If the current standard applicable corresponding to 12 antenna ports is effect, the transmitter shall configures parameters according to the standard for 12 antenna ports to determine the applicability of the RS pattern. This implementation makes the RS pattern adapt to the number of antenna ports, which is beneficial to the transmission of RS.

In some embodiments of the disclosure, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments of the disclosure, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in the scheduling unit.

In the embodiments of the disclosure, the smallest resource unit in the OTFS modulation is composed of one OTFS symbol in the delay domain and one OTFS subcarrier in the Doppler domain, where N represents the number of delay-domain OTFS symbols in the scheduling unit of the transmitter, M represents the number of Doppler-domain OTFS subcarriers in the scheduling unit, M_{g} represents the number of OTFS symbols corresponding to the guard in the delay domain, and N_{g} represents the number of OTFS subcarriers corresponding to the guard in the Doppler domain.

In the embodiment of the disclosure, the first symbol may represent any symbol of an RS sequence, Nₚ represents a Doppler-domain subcarrier length corresponding to a sending position of all symbols in the RS sequence, i.e., a length occupied by the RS sending positions in the Doppler domain, and Mₚ represents a delay-domain symbol length corresponding to a sending position of all symbols in the RS sequence, i.e., a length occupied by the RS sending position in the time domain.

In the embodiment of the disclosure, 0<lₚ<N−1, limiting the delay-domain index lₚ of the RS sending position within a delay-domain OTFS symbol length in a scheduling unit; 0<kₚ<M−1, limiting the Doppler-domain index kₚ of the RS sending position within a Doppler-domain OTFS subcarrier in a scheduling unit; 0<lₚ−N_{g}<lₚ<lₚ+N_{g}<N−1, indicating that interval N_{g} is reserved for the RS sending position in the delay domain as the guard to prevent non-zero signals from being received by the receiver at a “zero” position set by the transmitter due to delay frequency shift; 0<kₚ−M_{g}<kₚ<kₚ+M_{g}<M−1, indicating that interval M_{g} is reserved for the RS sending position in the Doppler domain as the guard to prevent non-zero signals from being received by the receiver at a “zero” position set by the transmitter due to Doppler frequency shift.

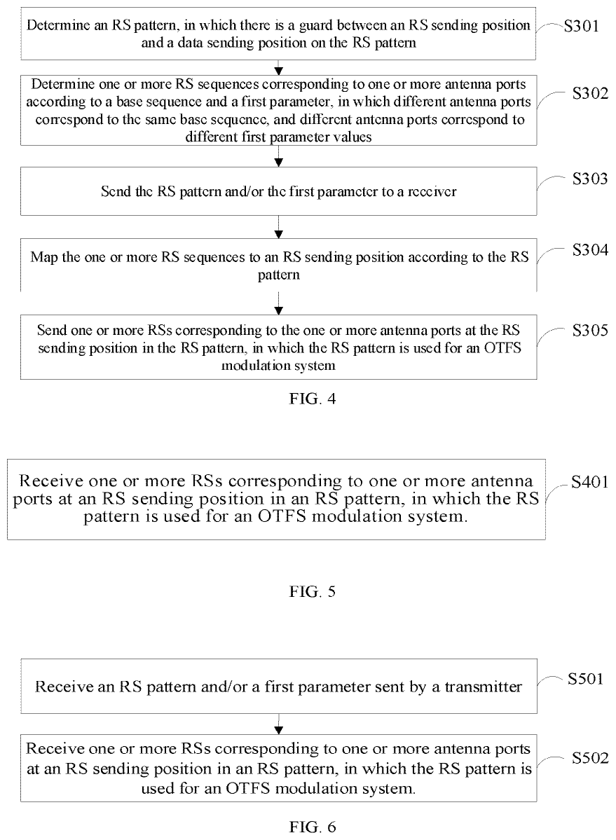

In an embodiment, as illustrated in FIG. 4, the coordinates of the first symbol in the DD domain are (lₚ, kₚ). If the first symbol refers to the coordinates at the lower-left corner of the gray region in the figure, where k represents a Doppler-domain index of an RS sending position and l represents a delay domain index of the RS sending position, then the index of the RS sending position is as follows:

k=kₚ, . . . , kₚ+Nₚ−1, l=lₚ, . . . , lₚ+Mₚ−1

At step S202, one or more RSs corresponding to one or more antenna ports are sent at the RS sending position on the RS pattern.

The RS pattern is used for an OTFS modulation system.

The specific explanation of step S202 can refer to step S101 in the embodiment of FIG. 1, which will not be repeated here.

In conclusion, according to the communication method of the disclosure, the transmitter determines the RS pattern where the guard is provided between the RS sending position and the data sending position in the RS pattern. The one or more RSs corresponding to the one or more antenna ports are sent at the RS sending position in the RS pattern, and the RS pattern is used for the OTFS modulation system. The communication method establishes the RS sending position pattern and the RS sending solution that are applicable to a MIMO-OTFS system, thereby enabling the transmission of RS in the MIMO-OTFS system.

Based on the embodiment of FIG. 1 and/or the embodiment of FIG. 2, FIG. 4 is a flowchart of a communication method according to an embodiment of the disclosure. The method is performed by a transmitter.

As illustrated in FIG. 4, the method includes the following steps.

At step S301, an RS pattern is determined.

There is a guard between an RS sending position and a data sending position in the RS pattern. The guard blocks negative effects of delay frequency shift and Doppler frequency shift.

In some embodiments of the disclosure, determining the RS pattern, includes: determining the number of antenna ports; determining a configuration parameter of the RS pattern; and determining the RS pattern according to a protocol based on the number of antenna ports and the configuration parameter. This implementation makes the RS pattern adapt to the number of antenna ports, which is beneficial to the transmission of RS.

In some embodiments of the disclosure, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments of the disclosure, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in the scheduling unit.

The specific explanation of step S301 can refer to step S201 in the embodiment of FIG. 2, which will not be repeated here.

At step S302, one or more RS sequences corresponding to one or more antenna ports are determined according to a base sequence and a first parameter.

Different antenna ports correspond to the same base sequence, and different antenna ports correspond to different values of the first parameter. This implementation ensures that the sequences are orthogonal to each other.

In the embodiment of the disclosure, assuming that there are a plurality of antenna ports, and the RS of each antenna port corresponds to the same position in the DD domain, the RS sequence of each antenna port is sent at the same position on the RS pattern, but the RS sequences of different antenna ports are different.

In some embodiments, the RS sequences used by different antenna ports are mutually orthogonal. To ensure orthogonality among RS sequences of different antenna ports, a base sequence and a first parameter are used to determine the RS sequence corresponding to each antenna port.

In the embodiment of the disclosure, the base sequence is a basic sequence of the RS. Multiple different RS sequences are defined by the base sequence through different shift parameter values.

The base sequence is a pseudorandom sequence, which may be a Zaddoff-Chu (ZC) sequence, an M sequence, a Gold sequence or other sequences, which is not limited in the disclosure.

In some embodiments of the disclosure, the first parameter includes any one of: an OCC or a cyclic shift offset.

In an implementation, the RS sequences for different antenna ports employ the same base sequence with different OCCs. Before sending the RS sequence corresponding to an antenna port, the OCCs corresponding to the antenna ports must be sent to the receiver.

OCC is an orthogonal cover code. By appending different OCCs to the base sequence as RS sequences for different antenna ports, it is ensured that the RS sequences for different antenna ports remains mutually orthogonal. Specifically, Walsh function orthogonal codes composed of {+1, −1} may be employed, or alternatively other OCCs may be adopted; the present disclosure is not limited thereto.

In another implementation, the RS sequences for different antenna ports employ the same base sequence withe different cyclic shift offsets. Before sending the RS sequence corresponding to an antenna port, the cyclic shift offsets corresponding to the antenna ports must be sent to the receiver.

For example, an RS sequence for a first antenna port is determined by cyclic shifting the base sequence 4 bits, while an RS sequence of a second antenna port is determined by cyclic shifting the base sequence 8 bits. It is sufficient to inform the receiver of the number of bits to be cyclically shifted.

In other embodiments, the terminal may be informed of the type of cyclic shift based on the number of antenna ports. For example, with t are 8 antenna ports and a 128 bits RS sequence, if the type of cyclic shift includes type1 (8 bits) and type2 (16 bits), simply inform the receiver of the type of cyclic shift.

At step S303, the RS pattern and/or the first parameter is sent to a receiver.

In the embodiment of the disclosure, it is necessary to inform the receiver of the RS pattern and the first parameter of the antenna port used when sending the RS in advance, for the receiver to distinguish RSs for different antenna ports and perform RS demodulation.

In the embodiment of the disclosure, since different antenna ports correspond to the same base sequence, the receiver only needs to obtain the first parameter of the antenna port based on the base sequence agreed upon in the protocol to distinguish RSs of different antenna ports.

It should be understood that in the implementation of the solution, only the method for determining the RS pattern disclosed herein is adopted to send the RS pattern to the receiver, and the orthogonality of transmission of RSs for different antenna ports is ensured by other means. Or, only the method for determining the orthogonality of RS sequences for different antenna ports disclosed herein is adopted to send the first parameter to the receiver, and the RS pattern used for the OTFS modulation system is determined by other means, which is not limited in the disclosure.

At step S304, the one or more RS sequences are mapped to an RS sending position according to the RS pattern.

That is, the transmitter maps the one or more RS sequences onto the same RS sending position in the DD domain according to the RS pattern, to send the RS at the corresponding sending position.

In some embodiments of the disclosure, mapping the one or more RS sequences to the RS sending position according to the RS pattern includes: mapping the one or more RS sequences to the RS sending position according to the RS pattern in a preset mapping order.

That is, the one or more RS sequences are mapped to the RS sending position according to the RS pattern in the preset mapping order. For example, on the RS pattern shown in FIG. 4, the RS sending position is placed first in the delay domain direction and then in the Doppler domain direction, or first in the Doppler domain direction and then in the delay domain direction, or in any other preset order, which is not limited in the disclosure. However, the mapping order needs to be pre-determined, so that different RS sequences are mapped in the same mapping order, thereby preventing the orthogonality of different RS sequences from being compromised.

At step S305, one or more RSs corresponding to the one or more antenna ports are sent at the RS sending position on the RS pattern.

The RS pattern is used for an OTFS modulation system.

The specific explanation of step S305 can refer to step S101 in the embodiment of FIG. 1, which will not be repeated here.

In conclusion, according to the communication method of the disclosure, the communication method generates the RS sending position pattern and the RS sending solution. Each antenna port corresponds to the same RS sending position, and the RS sequences of different antenna ports are mutually orthogonal. The transmitter determines the RS pattern and determines the one or more RS sequences corresponding to the one or more antenna ports based on the base sequence and the first parameter, and sends the RS pattern and/or the first parameter to the receiver. It maps the one or more RS sequences to the RS sending position according to the RS pattern, and sends the one or more RSs corresponding to the one or more antenna ports at the RS sending position in the RS pattern. The method is applied to the MIMO-OTFS system, to enable the transmission of RS in the MIMO-OTFS system.

FIG. 5 is a flowchart of a communication method according to an embodiment of the disclosure. The method is performed by a receiver.

As illustrated in FIG. 5, the method includes the following steps.

At step S401, one or more RSs corresponding to one or more antenna ports are received at an RS sending position in an RS pattern.

The RS pattern is used for an OTFS modulation system.

In the embodiment of the disclosure, the RS may also be referred to as a “pilot” signal, which is a known signal sent by a transmitter to the receiver for channel estimation or channel detection. The RS includes, but is not limited to, a DMRS, a PTRS, an SRS and a CSI-RS

In the embodiment of the disclosure, the receiver corresponds to the transmitter. If the transmitter is a terminal, the receiver is a network device. If the transmitter is a network device, the receiver is a terminal, which is not limited in the disclosure.

In the embodiment of the disclosure, the RS pattern is used for the OTFS modulation system. The OTFS modulation system transmits information in the DD domain. The position coordinates in the RS pattern include a coordinate in the delay domain and a coordinate in the Doppler domain. The disclosure specifies the RS sending position in the RS pattern, e.g., by defining a coordinate in the Doppler domain and a coordinate in the delay domain of the RS sending position in the RS pattern.

In some embodiments of the disclosure, each antenna port has the same RS pattern, meaning that the RSs for different antenna ports are sent at the same sending position in the DD domain.

In some embodiments of the disclosure, since the RS sequences of different antenna ports are different and exhibit orthogonality, when the receiver receives one or more RSs corresponding to several antenna ports, the RS of each antenna port can be distinguished, thereby making it suitable for application in MIMO multi-antenna systems.

It should be noted that the solution disclosed in the disclosure is applicable to an OTFS modulation system or a MIMO multi-antenna system, to solve the issue of RS transmission in the MIMO-OTFS system or to promote the construction of the MIMO-OTFS system, so as to promote the construction of communication systems that meet their communication performance requirements in high-mobility scenarios.

In conclusion, according to the communication method of the disclosure, the receiver receives the one or more RSs corresponding to the one or more antenna ports at the RS sending position in the RS pattern, which is used for the OTFS modulation system. The communication method is applied to a MIMO-OTFS system, to enable the transmission of RS in the MIMO-OTFS system.

Based on the embodiment shown in FIG. 5, FIG. 6 is a flowchart of a communication method according to an embodiment of the disclosure. The method is performed by a receiver.

As illustrated in FIG. 6, the method includes the following steps.

At step S501, an RS pattern and/or a first parameter sent by a transmitter is received.

In some embodiments of the disclosure, there is a guard between an RS sending position and a data sending position on the RS pattern. The guard can block negative effects of delay frequency shift and Doppler frequency shift.

In some embodiments, the guard should be greater than or equal to the maximum delay spread of the channel in the delay domain and greater than or equal to the maximum Doppler frequency shift in the Doppler domain.

In some embodiments of the disclosure, the RS pattern is determined according to a protocol based on the number of antenna ports and a configuration parameter of the RS pattern.

In some embodiments of the disclosure, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments of the disclosure, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in the scheduling unit.

It should be noted that the above embodiment corresponds to the embodiment of step S201 in FIG. 2, and details can refer to the specific explanation of the embodiment of step S201 in FIG. 2, which will not be repeated herein.

In some embodiments of the disclosure, one or more RS sequences are mapped to the RS sending position according to the RS pattern.

In some embodiments of the disclosure, one or more RS sequences are mapped to the RS sending position according to the RS pattern in a preset mapping order.

In some embodiments of the disclosure, one or more RS sequences corresponding to one or more antenna ports are determined according to a base sequence and a first parameter, in which different antenna ports correspond to the same base sequence, and different antenna ports correspond to different values of the first parameter. This implementation ensures that the sequences are orthogonal to each other.

In some embodiments of the disclosure, the first parameter includes any one of: an OCC or a cyclic shift offset.

It should be noted that the above embodiment corresponds to the embodiments of steps S302-S304 in FIG. 3, and details can refer to the specific explanation of the embodiments of steps S302-S304 in FIG. 3, which will not be repeated herein.

In the embodiment of the disclosure, since different antenna ports correspond to the same base sequence, the receiver only needs to receive the first parameter of the antenna port to distinguish the RS sent by that antenna port.

In the embodiment of the disclosure, the receiver pre-acquires the RS pattern used by the transmitter to send the RS and the first parameter of the antenna port, to distinguish the RSs of different antenna ports and perform RS demodulation upon receiving the RS.

It should be understood that in the implementation of the solution, only the RS pattern sent by the transmitter is received, and the RSs sent by different antenna ports are distinguished by other means, or only the first parameter sent by the transmitter is received, and the RS pattern used for the OTFS modulation system is determined by other means, which is not limited in the disclosure.

At step S502, one or more RSs corresponding to one or more antenna ports are received at an RS sending position in an RS pattern.

The RS pattern is used for an OTFS modulation system.

The specific explanation of step S502 can refer to step S401 in the embodiment of FIG. 5, which will not be repeated here.

In conclusion, according to the communication method of the disclosure, the receiver receives the RS pattern and/or the first parameter sent by the transmitter, and receives the one or more RSs corresponding to the one or more antenna ports at the RS sending position in the RS pattern. The RS pattern is designed for the OTFS modulation system. The communication method is applied to a MIMO-OTFS system, to enable the transmission of RS in the MIMO-OTFS system.

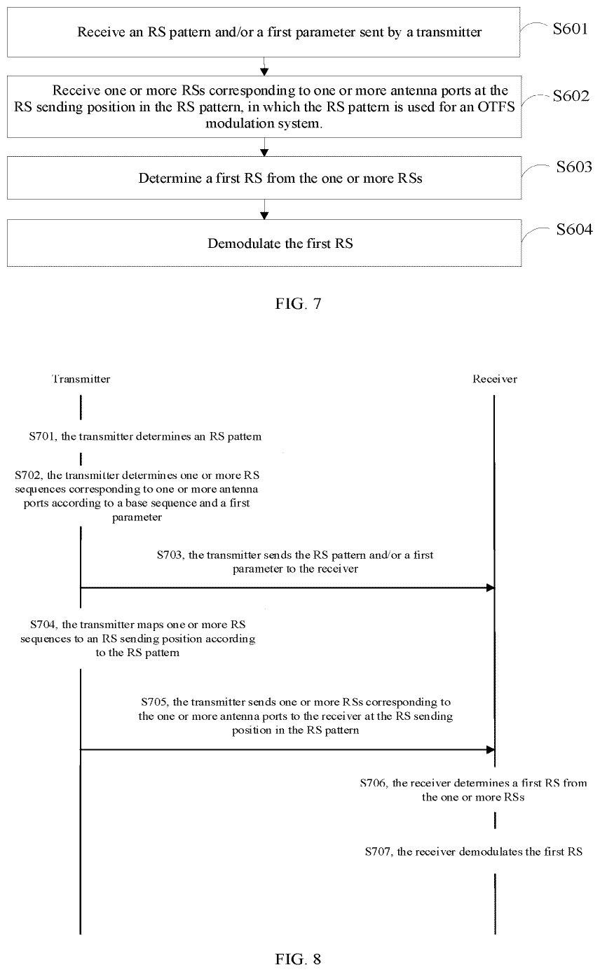

Based on the embodiment shown in FIG. 5 and/or the embodiment shown in FIG. 6, FIG. 7 is a flowchart of a communication method according to an embodiment of the disclosure. The method is performed by a receiver.

As illustrated in FIG. 7, the method includes the following steps.

At step S601, an RS pattern and/or a first parameter sent by a transmitter is received.

In some embodiments of the disclosure, there is a guard between an RS sending position and a data sending position on the RS pattern. The guard blocks negative effects of delay frequency shift and Doppler frequency shift.

In some embodiments of the disclosure, the RS pattern is determined according to a protocol based on the number of antenna ports and a configuration parameter of the RS pattern.

In some embodiments of the disclosure, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments of the disclosure, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler domain OTFS subcarriers in the scheduling unit.

It should be noted that the above embodiment corresponds to the embodiment of step S201 in FIG. 2, and details can refer to the specific explanation of the embodiment of step S201 in FIG. 2, which will not be repeated herein.

In some embodiments of the disclosure, one or more RS sequences are mapped to the RS sending position according to the RS pattern.

In some embodiments of the disclosure, one or more RS sequences are mapped to the RS sending position according to the RS pattern in a preset mapping order.

In some embodiments of the disclosure, one or more RS sequences corresponding to one or more antenna ports are determined according to a base sequence and a first parameter, in which different antenna ports correspond to the same base sequence, and different antenna ports correspond to different values of the first parameter. This implementation ensures that the sequences are orthogonal to each other.

In some embodiments of the disclosure, the first parameter includes any one of: an OCC or a cyclic shift offset.

It should be noted that the above embodiment corresponds to the embodiments of steps S302-S304 in FIG. 3, and details can refer to the specific explanation of the embodiments of steps S302-S304 in FIG. 3, which will not be repeated herein.

At step S602, one or more RSs corresponding to one or more antenna ports are received at the RS sending position in the RS pattern.

The RS pattern is used for an OTFS modulation system.

The specific explanation of step S602 can refer to step S401 in the embodiment of FIG. 5, which will not be repeated here.

At step S603, a first RS is determined from the one or more RSs.

At step S604, the first RS is demodulated.

In the embodiments of the disclosure, the RSs of different antenna ports are sent at the same sending position in the DD domain. Correspondingly, the receiver receives all these RSs at the sending position. During demodulation, the receiver selects RSs for demodulation based on actual requirements.

In the embodiments of the disclosure, the first RS is an RS selected by the receiver from the one or more received RSs based on its requirements. There may be one or more first RSs, and the number of first RSs is not limited by the disclosure.

In conclusion, according to the communication method of the disclosure, the receiver receives the RS pattern and/or the first parameter sent by the transmitter, and receives the one or more RSs corresponding to the one or more antenna ports at the RS sending position in the RS pattern. The RS pattern is used for the OTFS modulation system. It also determines the first RS from the one or more RSs and then demodulates the first RS. This communication method is applied to the MIMO-OTFS system, to enable the transmission of RS in the MIMO-OTFS system.

It should be noted that different embodiments in the disclosure may be combined for implementation, and the appropriate implementation is selected depends on the application scenario, which is not limited in the disclosure.

FIG. 8 is an interactive schematic diagram of a communication method according to an embodiment of the disclosure. As illustrated in FIG. 8, the embodiment involves data/signaling interactions between a transmitter and a receiver when executing the communication method. Based on the embodiments shown in FIGS. 1-7, the method includes the following steps.

At step S701, the transmitter determines an RS pattern.

In some embodiments of the disclosure, determining the RS pattern, includes: determining the number of antenna ports; determining a configuration parameter of the RS pattern; and determining the RS pattern according to a protocol based on the number of antenna ports and the configuration parameter. This implementation makes the RS pattern adapt to the number of antenna ports, which is beneficial to the transmission of RS.

In some embodiments of the disclosure, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments of the disclosure, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in the scheduling unit.

At step S702, the transmitter determines one or more RS sequences corresponding to one or more antenna ports according to a base sequence and a first parameter.

Different antenna ports correspond to the same base sequence, and different antenna ports correspond to different first parameter values. This implementation ensures that the sequences are orthogonal to each other.

In some embodiments of the disclosure, the first parameter includes any one of: an OCC or a cyclic shift offset.

At step S703, the transmitter sends the RS pattern and/or a first parameter to the receiver.

At step S704, the transmitter maps one or more RS sequences to an RS sending position according to the RS pattern.

In some embodiments of the disclosure, mapping the one or more RS sequences to the RS sending position according to the RS pattern includes: mapping the one or more RS sequences to the RS sending position according to the RS pattern in a preset mapping order.

At step S705, the transmitter sends one or more RSs corresponding to the one or more antenna ports to the receiver at the RS sending position in the RS pattern.

The RS pattern is used for an OTFS modulation system.

At step S706, the receiver determines a first RS from the one or more RSs.

At step S707, the receiver demodulates the first RS.

After receiving a plurality of RSs according to the reference pattern, the receiver determines which RSs to demodulate based on requirements.

It should be understood that steps S701-S704, steps S706-S707 are optional. One or more or all of these steps may be implemented selectively, which is not limited by the disclosure. The order of execution of these steps is not limited in the embodiments of the disclosure.

The steps S701-S707 described above follow the same principles as those illustrated in FIGS. 1-7, and details can refer to the descriptions of FIGS. 1-7, which will not be repeated herein.

In conclusion, according to the communication method provided by the embodiments of the disclosure, the RS sending position pattern and the RS sending solution are generated. The transmitter sends the one or more RSs corresponding to the one or more antenna ports to the receiver at the RS sending position in the RS pattern. The RS pattern is used for the OTFS modulation system. The communication method is applied to a MIMO-OTFS system, to enable the transmission of RS in the MIMO-OTFS system.

In the embodiments of the disclosure, the methods described in the disclosure are introduced from the perspectives of both the network device and the UE. To implement the various functions described in the method embodiments, the network device and the UE may include a hardware structure and a software module, and may implement the functions through the hardware structure, the software module, or a combination of the hardware structure and the software module. A certain function described above may be executed using the hardware structure, the software module, or a combination of the hardware structure and the software module.

Corresponding to the communication method provided in the above embodiments, the disclosure also provides a communication apparatus. Since the communication apparatus provided in the embodiments of the disclosure corresponds to the communication method provided in the above embodiments, the implementations of the communication method are also applicable to the communication apparatus provided in the embodiment, which will not be described in detail in the embodiment.

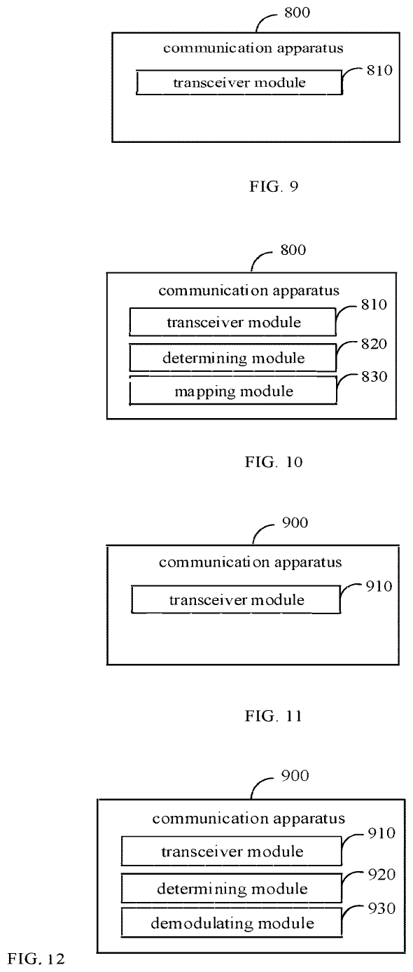

FIG. 9 is a schematic block diagram of a communication apparatus 800 according to an embodiment of the disclosure.

As illustrated in FIG. 9, the apparatus 800 includes: a transceiver module 810, configured to send one or more RSs corresponding to one or more antenna ports at an RS sending position in an RS pattern, in which the RS pattern is used for an OTFS modulation system.

According to the communication apparatus provided in the embodiment of the disclosure, a transmitter sends the one or more RSs corresponding to the one or more antenna ports at the RS sending position in the RS pattern through the transceiver module, in which the RS pattern is used for the OTFS modulation system. The communication method is applied to a MIMO-OTFS system, to enable the transmission of RS in the MIMO-OTFS system and solve the problem that the RS cannot be sent in the MIMO-OTFS system.

In some embodiments, as illustrated in FIG. 10, the apparatus 800 further includes: a determining module 820, configured to determine the RS pattern, in which there is a guard between the RS sending position and a data sending position on the RS pattern.

In some embodiments, the determining module 820 is further configured to: determine the number of antenna ports; determine a configuration parameter of the RS pattern; and determine the RS pattern according to a protocol based on the number of antenna ports and the configuration parameter.

In some embodiments, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in the scheduling unit.

In some embodiments of the disclosure, the determining module 820 is further configured to: determine one or more RS sequences corresponding to the one or more antenna ports according to a base sequence and a first parameter, in which different antenna ports correspond to the same base sequence, and different antenna ports correspond to different first parameter values.

In some embodiments, the first parameter includes any one of: an OCC or a cyclic shift offset.

In some embodiments of the disclosure, the determining module 820 is further configured to: send the RS pattern and/or the first parameter to a receiver.

In some embodiments, as illustrated in FIG. 10, the apparatus further includes: a mapping module 830, configured to map the one or more RS sequences to the RS sending position according to the RS pattern.

In some embodiments, the mapping module 830 is further configured to: map the one or more RS sequences to the RS sending position according to the RS pattern in a preset mapping order.

In conclusion, according to the communication apparatus provided in the disclosure, through its transceiver module, determining module and mapping module, the RS sending position pattern and the RS sending solution are generated. Each antenna port has the same RS sending position pattern, the one or more RS sequences are mapped to the RS sending position, and the one or more RSs corresponding to the one or more antenna ports are sent at the RS sending position in the RS pattern by utilizing the orthogonality of RS sequences for different antenna ports. It can be applied to a MIMO-OTFS system, to realize the function of sending the RS in the MIMO-OTFS system and solve the problem that the RS cannot be sent in the MIMO-OTFS system.

FIG. 11 is a schematic structural diagram of a communication apparatus 900 according to an embodiment of the disclosure.

As illustrated in FIG. 11, the apparatus 900 includes: a transceiver module 910, configured to receive one or more RSs corresponding to one or more antenna ports at an RS sending position in an RS pattern, in which the RS pattern is used for an OTFS modulation system.

According to the communication apparatus provided by the disclosure, a receiver receives the one or more RSs corresponding to the one or more antenna ports at the RS sending position in the RS pattern through the transceiver module, in which the RS pattern is used for the OTFS modulation system. The communication apparatus is applied to a MIMO-OTFS system, to enable the transmission of RS in the MIMO-OTFS system and solve the problem that the RS cannot be sent in the MIMO-OTFS system.

In some embodiments, there is a guard between the RS sending position and a data sending position on the RS pattern.

In some embodiments, the RS pattern is determined according to a protocol based on a number of antenna ports and a configuration parameter of the RS pattern.

In some embodiments, the configuration parameter includes at least one of: a delay-domain index lₚ of a first symbol sending position, the first symbol being a symbol of an RS sequence; a Doppler-domain index kₚ of a first symbol sending position; a number of OTFS symbols M_{g} corresponding to the guard in a delay domain; a number of OTFS subcarriers N_{g} corresponding to the guard in a Doppler domain; a Doppler-domain subcarrier length Nₚ corresponding to an RS sequence; or a delay-domain symbol length Mₚ corresponding to an RS sequence.

In some embodiments, the lₚ satisfies a first condition: 0<lₚ−N_{g}<lₚ<lₚ+N_{g}<N−1, where N represents a number of delay-domain OTFS symbols in a scheduling unit; and the kₚ satisfies a second condition: 0<kₚ−M_{g}<kₚ<kₚ+M_{g}<M−1, where M represents a number of Doppler-domain OTFS subcarriers in t the scheduling unit.

In some embodiments, one or more RS sequences corresponding to the one or more antenna ports are determined according to a base sequence and a first parameter, in which different antenna ports correspond to the same base sequence, and different antenna ports correspond to different first parameter values.

In some embodiments, the first parameter includes any one of: an OCC or a cyclic shift offset.

In some embodiments, the transceiver module 910 is further configured to: receive the RS pattern and/or the first parameter sent by a transmitter.

In some embodiments, the one or more RS sequences are mapped to the RS sending position according to the RS pattern.

In some embodiments, the one or more RS sequences are mapped to the RS sending position according to the RS pattern in a preset mapping order.

In some embodiments, as illustrated in FIG. 12, the apparatus 900 further includes: a determining module 920 and a demodulating module 930. The determining module 920 is configured to determine a first RS from the one or more RSs, and the demodulating module 930 is configured to demodulate the first RS.

According to the communication apparatus provided in the disclosure, through its transceiver module, determining module and demodulating module, the RS sending position pattern and the RS sending solution are generated. Each antenna port has the same RS sending position pattern, the one or more RS sequences are mapped to the RS sending position, and the one or more RSs corresponding to the one or more antenna ports are received at the RS sending position on the RS pattern by utilizing the orthogonality of RS sequences of different antenna ports. It can be applied to a MIMO-OTFS system, to realize the function of sending the RS in the MIMO-OTFS system and solve the problem that the RS cannot be sent in the MIMO-OTFS system.

The embodiment of the disclosure provides a communication system, which is applied to a core network. The communication system may be an LTE system, a 5G mobile communication system, a 5G NR system, or other future new mobile communication systems.

The communication system includes a transmitter and a receiver.

The transmitter is configured to implement the method of any one of the embodiments shown in FIGS. 1-4 above;

The receiver is configured to implement the method of any one of the embodiments shown in FIGS. 5-7 above;

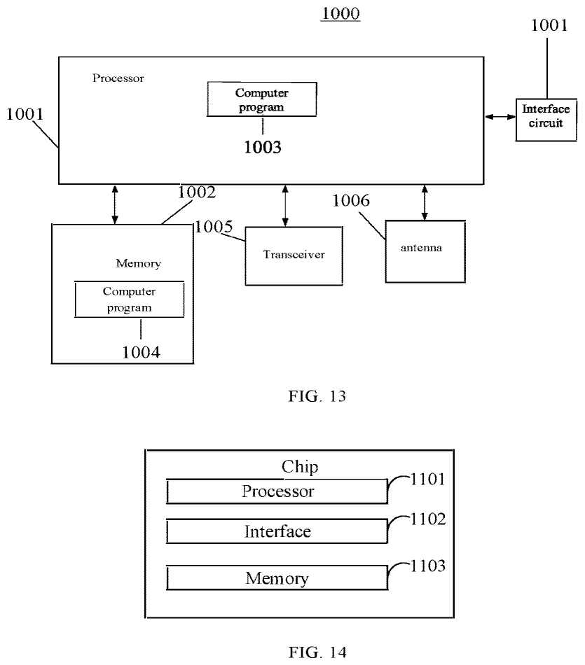

As illustrated in FIG. 13, FIG. 13 is a schematic structural diagram of a communication device 1000 provided by an embodiment of the disclosure. The communication device 1000 may be a network device, a UE, or a chip, a chip system or a processor that supports the network device to implement the above method, or a chip, a chip system or a processor that supports the UE to implement the above method. The device is used to implement the method described in the above method embodiments with reference to the descriptions of the method embodiments.

The communication device 1000 includes one or more processors 1001. The processor 1001 may be a general purpose processor or a dedicated processor, such as, a baseband processor or a central processor. The baseband processor is configured to process communication protocols and communication data, while the central processor is configured to control the communication device (e.g., base station, baseband chip, terminal, terminal chip, DU or CU), execute computer programs, and process data of the computer programs.

The communication device 1000 may also include one or more memories 1002 on which a computer program 1004 is stored. The processor 1001 executes the computer program 1004 to cause the communication device 1000 to implement the above method described in the method embodiments. The memory 1002 may also store data. The communication device 1000 and the memory 1002 may be provided separately or may be integrated together.

The communication device 1000 may also include a transceiver 1005 and an antenna 1006. The transceiver 1005 may be referred to as transceiver unit, transceiver machine or transceiver circuit, for implementing a transceiver function. The transceiver 1005 may include a receiver and a transmitter. The receiver may be referred to as receiver machine or receiving circuit, for implementing a receiving function, and the transmitter may be referred to as transmitter machine or transmitting circuit, for implementing a transmitting function.

The communication device 1000 may also include one or more interface circuits 1007. The interface circuit 1007 is configured to receive code instructions and transmit them to the processor 1001. The processor 1001 runs the code instructions to cause the communication device 1000 to implement the method described in the method embodiments.

In an implementation, the processor 1001 may include a transceiver for implementing the receiving and transmitting functions. The transceiver may be, for example, a transceiver circuit, an interface or an interface circuit. The transceiver circuit, interface or interface circuit for implementing the receiving and transmitting functions may be separated or may be integrated together. The transceiver circuit, interface or interface circuit described above may be used for code/data reading and writing, or signal transmission or delivery.

In an implementation, the processor 1001 may store a computer program 1003, which runs on the processor 1001 and causes the communication device 1000 to implement the above method described in the method embodiments. The computer program 1003 may be solidified in the processor 1001, in which case the processor 1001 may be implemented by hardware.

In an implementation, the communication device 1000 may include circuits. The circuits may implement the sending, receiving or communicating function in the method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may be produced using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the descriptions of the above embodiments may be a network device or a UE, but the scope of the communication device described in the disclosure is not limited thereto, and the structure of the communication device is not limited by FIG. 13. The communication device may be a stand-alone device or may be part of a larger device. For example, the described communication device may be:
(1) a stand-alone IC, chip, chip system or subsystem;
(2) a collection of ICs including one or more ICs (the collection of ICs may also include storage components for storing data and computer programs);
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

The case where the communication device may be a chip or a chip system can refer to a schematic structural diagram of a chip shown in FIG. 14. The chip in FIG. 14 includes a processor 1101 and an interface 1102. There may be one or more processors 1101 and a plurality of interfaces 1102.

The chip may also include a memory 1103 for storing necessary computer programs and data.

The disclosure also provides a computer storage medium. The computer storage medium stores computer executable instructions, the computer executable instructions are used to cause a processor to implement the functions of any of the above method embodiments.

It is understandable by those skilled in the art that various illustrative logical blocks and steps listed in the embodiments of the disclosure are implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer programs on the computer, all or part of processes or functions described in the embodiments of the disclosure are implemented. The computer may be a general-purpose computer, a dedicated computer, a computer network, or a programmable device. The computer program may be stored in a computer-readable storage medium or transmitted from one computer-readable storage medium to another computer-readable storage medium. For example, the computer program may be transmitted from one web site, computer, server or data center to another web site, computer, server or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium accessible by the computer or a data storage device integrated by one or more usable mediums, such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure or indicate the order of precedence.

The term “at least one” in the disclosure may also be described as one or more, and the term “a plurality of” may be two, three, four or more, which is not limited in the disclosure. In the embodiments of the disclosure, for a type of technical features, “first”, “second” and “third”, and “A”, “B”, “C” and “D” are used to distinguish different technical features of the type, the technical features described using the “first”, “second” and “third”, and “A”, “B”, “C” and “D” do not indicate any order of precedence or magnitude.

As used herein, the terms “machine-readable medium” and “computer-readable medium” refer to any computer program product, device and/or apparatus (e.g., disk, compact disc read-only memories (CD-ROM), memory, programmable logic device (PLD)) used to provide machine instructions and/or data to a programmable processor, including machine-readable medium that receives machine instructions as machine-readable signals. The term “machine-readable signal” refers to any signal used to provide machine instructions and/or data to the programmable processor.

The systems and technologies described herein can be implemented in a computing system that includes back-end components (for example, a data server), a computing system that includes middleware components (for example, an application server), a computing system that includes front-end components (for example, a user computer with a graphical user interface or a web browser, through which the user can interact with the implementations of the systems and technologies described herein), or a computing system that includes any combination of such back-end components, intermediate components and front-end components. The components of the system may be interconnected by any form or medium of digital data communication (e.g., a communication network). Examples of communication networks include: a local area network (LAN), a wide area network (WAN), and the Internet.

The computer system may include a client and a server. The client and the server are generally remote from each other and interact through a communication network. The client-server relation is generated by computer programs running on the respective computers and having a client-server relation with each other.

It is understandable that the steps can be reordered, added or deleted using various forms of the processes shown above. For example, the steps in the disclosure may be performed in parallel, sequentially or in different orders, as long as the desired results of the technical solutions of the disclosure are achieved, which are not limited herein.

In addition, it should be understood that the embodiment of the disclosure may be implemented independently or in combination with other embodiments if the solution permits.

Those skilled in the art may realize that units and algorithmic steps of the various examples described in combination with the embodiments disclosed herein are capable of being implemented by electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can refer to the corresponding processes in the above method embodiments, which will not be repeated herein.

The above descriptions are specific implementations of the disclosure, but the protection scope of the disclosure is not limited thereto. Any technician familiar with the technical field can easily think of changes or substitutions within the technical scope disclosed in the disclosure, and these changes or substitutions should be included in the protection scope of the disclosure. Therefore, the protection scope of the disclosure should be based on the protection scope of the claims.

1. A communication method, performed by a transmitter, comprising:
sending one or more reference signals corresponding to one or more antenna ports at a reference signal sending position in a reference signal pattern,
wherein the reference signal pattern is used for an orthogonal time frequency and space (OTFS) modulation system.

2. The method of claim 1, further comprising:
determining the reference signal pattern,
wherein a guard is provided between the reference signal sending position and a data sending position in the reference signal pattern.

3. The method of claim 2, wherein determining the reference signal pattern comprises:
determining a number of the one or more antenna ports;
determining a configuration parameter of the reference signal pattern; and
determining the reference signal pattern according to a protocol based on the number of the one or more antenna ports and the configuration parameter.

4. The method of claim 3, wherein the configuration parameter comprises at least one of:
a delay-domain index lₚ of a first symbol sending position, the first symbol being a symbol of a reference signal sequence;
a Doppler-domain index kₚ of a first symbol sending position;
a number of OTFS symbols M_{g} corresponding to the guard in a delay domain;
a number of OTFS subcarriers N_{g} corresponding to the guard in a Doppler domain,
a Doppler-domain subcarrier length Nₚ corresponding to a reference signal sequence; or
a delay-domain symbol length Mₚ corresponding to a reference signal sequence.

5. The method of claim 4, wherein
the lₚ satisfies a first condition:
0<lₚ−N_{g}<lₚ<lₚ+N_{g}<N−1, where N represents a number of delay-domain OTFS symbols in a scheduling unit; and
the kₚ satisfies a second condition:
0<kₚ−M_{g}<kₚ<kₚ+M_{g}<M−1, where M represents a number of Doppler-domain OTFS subcarriers in the scheduling unit.

6. The method of claim 1, further comprising:
determining one or more reference signal sequences corresponding to the one or more antenna ports according to a base sequence and a first parameter,
wherein different antenna ports correspond to a same base sequence, and different antenna ports correspond to different values of the first parameter, and
wherein the first parameter comprises any one of:
an orthogonal cover code (OCC); or
a cyclic shift offset.

7. (canceled)

8. The method of claim 6, further comprising:
sending the reference signal pattern and/or the first parameter to a receiver.

9. The method of claim 6, further comprising:
mapping the one or more reference signal sequences to the reference signal sending position according to the reference signal pattern.

10. (canceled)

11. A communication method, performed by a receiver, comprising:
receiving one or more reference signals corresponding to one or more antenna ports at a reference signal sending position in a reference signal pattern,
wherein the reference signal pattern is used for an orthogonal time frequency and space (OTFS) modulation system.

12. The method of claim 11, wherein a guard is provided between the reference signal sending position and a data sending position in the reference signal pattern.

13. The method of claim 12, wherein the reference signal pattern is determined according to a protocol based on a number of the one or more antenna ports and a configuration parameter of the reference signal pattern.

14. The method of claim 13, wherein the configuration parameter comprises at least one of:
a delay-domain index lₚ of a first symbol sending position, the first symbol being a symbol of a reference signal sequence;
a Doppler-domain index kₚ of a first symbol sending position;
a number of OTFS symbols M_{g} corresponding to the guard in a delay domain;
a number of OTFS subcarriers N_{g} corresponding to the guard in a Doppler domain;
a Doppler-domain subcarrier length Nₚ corresponding to a reference signal sequence; or
a delay-domain symbol length Mₚ corresponding to a reference signal sequence.

15. The method of claim 14, wherein
the lₚ satisfies a first condition:
0<lₚ−N_{g}<lₚ<lₚ+N_{g}<N−1, where N represents a number of delay-domain OTFS symbols in a scheduling unit; and
the kₚ satisfies a second condition:
0<kₚ−M_{g}<kₚ<kₚ+M_{g}<M−1, where M represents a number of Doppler-domain OTFS subcarriers in the scheduling unit.

16. The method of claim 11, wherein
one or more reference signal sequences corresponding to the one or more antenna ports are determined according to a base sequence and a first parameter,
wherein different antenna ports correspond to a same base sequence, and different antenna ports correspond to different values of the first parameter, and
wherein the first parameter comprises any one of:
an orthogonal cover code (OCC); or
a cyclic shift offset.

17. (canceled)

18. The method of claim 16, further comprising:
receiving the reference signal pattern and/or the first parameter sent by a transmitter.

19. The method of claim 16, wherein
the one or more reference signal sequences are mapped to the reference signal sending position according to the reference signal pattern.

20. The method of claim 19, wherein
the one or more reference signal sequences are mapped to the reference signal sending position according to the reference signal pattern in a preset mapping order.

21. The method of claim 11, further comprising:
determining a first reference signal from the one or more reference signals; and
demodulating the first reference signal.

22-23. (canceled)

24. A communication device, comprising:
a transceiver;
a memory; and
a processor connected to the transceiver and the memory, respectively,
wherein the processor is configured to:
send one or more reference signals corresponding to one or more antenna ports at a reference signal sending position in a reference signal pattern,
wherein the reference signal pattern is used for an orthogonal time frequency and space (OTFS) modulation system.

25-26. (canceled)

27. A communication device, comprising:
a transceiver;
a memory; and
a processor connected to the transceiver and the memory, respectively,
wherein the processor is configured to implement the method of claim 11 by executing computer-executable instructions on the memory.
